(19) United States
(12) Patent Application Publication
(10) Pub. No.: US 2012/0044849 A1
(43) Pub. Date: Feb. 23, 2012

(54) POWER ALLOCATION IN CLOSED-LOOP DOWNLINK COOPERATIVE MULTIPLE POINT (COMP) TRANSMISSION

(75) Inventors: Hamidreza Farmanbar, Ottawa (CA); Amir Khandani, Ottawa (CA); Mohammadhadi Baligh, Kanata (CA); Hosein Nikopourdeilami, Stittsville (CA); Jianglei Ma, Kanata (CA)

(73) Assignee: CIENA CORPORATION, Linthicum, MD (US)

(21) Appl. No.: 13/147,000

(22) PCT Filed: Feb. 2, 2010
(86) PCT No.: PCT/CA10/00130

§ 371 Date: Sep. 23, 2011

Related U.S. Application Data
(60) Provisional application No. 61/149,125, filed on Feb. 2, 2009.

(51) Int. Cl. H04W 72/04; H04W 52/16; H04W 4/06

(52) U.S. Cl. 370/312; 370/329

(57) ABSTRACT

Techniques for power allocation among a plurality of network nodes in a communication network for cooperative downlink transmission to a mobile terminal are provided. Cooperative transmission to a mobile terminal is done in a selected one of a plurality of frequency bands allocated for cooperative downlink transmission, wherein each network node has a respective predetermined frequency band transmission power level for each of the plurality of frequency bands allocated for cooperative downlink transmission. Selection of the frequency band on which the mobile terminal will be cooperatively transmitted to is based on channel state information indicative of the channel between the mobile terminal and each of the network nodes and, for each of the frequency bands, the respective plurality of predetermined frequency band transmission power levels corresponding to the plurality of network nodes.

### CROSS REFERENCE TO RELATED APPLICATIONS

This application claims the benefit of prior U.S. Provisional Application Nos. 61/149,125 filed Feb. 2, 2009 hereby incorporated by reference in its entirety.

### FIELD OF THE INVENTION

The present invention relates to wireless communication techniques in general, and to techniques of power allocation in closed-loop downlink coordinated multiple point (CoMP) transmission, in particular.

### BACKGROUND OF THE INVENTION

Inter-cell interference (ICI) is a problem in wireless cellular networks.

Coordinated multiple-point (CoMP) transmission and/or reception has been proposed to improve coverage and to increase cell-edge and aggregate network throughput in emerging wireless technologies, such as, for example, the Long Term Evolution-Advanced (LTE-A) mobile communication standard that is being standardized by the 3^{rd} Generation Partnership Project (3GPP).

CoMP transmission/reception is also considered as an effective approach to address the ICI problem in LTE-A using inter-cell interference coordination (ICIC) that takes advantage of the inherent joint scheduling/processing at the network nodes of coordinated cells.

Downlink CoMP transmission may be considered to be divided into two categories:

a) Coordinated scheduling and/or beamforming; and

b) Joint processing/transmission.

In the category of coordinated scheduling and/or beamforming, the data to a single mobile terminal (UE) is transmitted from the network node, which in the case of LTE-A is an evolved-Node B (eNB), of the serving cell of the UE only; however, scheduling decisions are coordinated to control, e.g., the interference generated in a set of coordinated cells.

In the joint processing/transmission category, data to a single UE is simultaneously transmitted from multiple eNBs, e.g., to (coherently or non-coherently) improve the received signal quality and/or cancel actively interference for other UEs.

It has been shown that coordination among all eNBs in the system provides significant increase in celledge and average cell throughputs. However, data/channel state information (CSI) sharing among all eNBs in the system requires high backhaul capacity and is considered to be complex to implement.

To reduce the complexity, cooperation among a limited number of eNBs for communicating with a particular UE may be considered. One issue related to CoMP transmission/reception is then to determine the coordinated cell cluster serving a specific UE in order to have, e.g, the largest cell throughput for an accepted level of scheduling complexity and backhaul capacity. Examples of cell selection for cell clustering for CoMP are discussed in “Cell Clustering CoMP Transmission/Reception” R1-084464 Nortel Networks Limited, 3GPP TSG-RAN Working Group 1 Meeting #55 Prague, Czech Republic November 2008, which is hereby incorporated by reference in its entirety.

While CoMP downlink transmission has been proposed for emerging mobile communication technologies, such as LTE-A, issues of power allocation among cooperating network nodes, and the affect of CoMP downlink transmission on the rest of the network has not been fully addressed.

### SUMMARY

According to one broad aspect of the present invention, there is provided a method in a network node, the method comprising:

transmitting from the network node to a mobile terminal on one of a plurality of frequency bands allocated for cooperative downlink transmission, the network node having a respective predetermined frequency band transmission power level for each of the plurality of frequency bands allocated for cooperative downlink transmission.

In some embodiments, the method further comprises:

transmitting an indication of the network node's respective predetermined frequency band transmission power level for each of the plurality of frequency bands allocated for cooperative downlink transmission.

In some embodiments, the method further comprises:

transmitting on each of the plurality of frequency bands allocated for cooperative downlink transmission, network node-specific reference symbols at the respective predetermined frequency band transmission power level of the frequency band.

In some embodiments, the method further comprises:

receiving channel state information indicative of a channel between the network node and the mobile terminal for each of the plurality of frequency bands.

In some embodiments, the method further comprises:

selecting one of the plurality of frequency bands allocated for cooperative downlink transmission having regard to the received channel state information, wherein transmitting from the network node to a mobile terminal on one of a plurality of frequency bands allocated for cooperative downlink transmission comprises transmitting from the network node to the mobile terminal on the selected one of the plurality of frequency bands allocated for cooperative downlink transmission.

In some embodiments, transmitting network node-specific reference symbols comprises transmitting common network node-specific reference symbols to each of a plurality of mobile terminals inclusive of the previously recited mobile terminal.

In some embodiments, transmitting to the mobile terminal on one of the plurality of frequency bands allocated for cooperative downlink transmission comprises transmitting from the network node to the mobile terminal in cooperation with at least one other network node in the same frequency band of the plurality of frequency bands allocated for cooperative downlink transmission, wherein each network node has a respective predetermined frequency band transmission power level for each of the plurality of frequency bands.

In some embodiments, the method further comprises:

transmitting to the mobile terminal in at least one frequency band that is not included in the plurality of frequency bands allocated for cooperative downlink transmission, wherein transmitting in the at least one frequency band that is not included in the plurality of frequency bands allocated for cooperative downlink transmission is done as a single-point transmission.

According to another broad aspect of the present invention, there is provided a network node comprising:

a radio transceiver configured to transmit to a mobile terminal on one of a plurality of frequency bands allocated for cooperative downlink transmission, the radio transmitter having a respective predetermined frequency band transmission power level for each of the plurality of frequency bands allocated for cooperative downlink transmission.

In some embodiments, the radio transceiver is further configured to transmit an indication of the network node's respective predetermined frequency band transmission power level for each of the plurality of frequency bands allocated for cooperative downlink transmission.

In some embodiments, the radio transceiver is further configured to transmit network node-specific reference symbols on each of the plurality of frequency bands allocated for cooperative downlink transmission at the respective predetermined frequency band transmission power level of the respective frequency band.

In some embodiments, the radio transceiver is further configured to receive channel state information indicative of a channel between the network node and the mobile terminal for each of the plurality of frequency bands.

In some embodiments, the network node further comprises a processor configured to select one of the plurality of frequency bands allocated for cooperative downlink transmission having regard to the channel state information, wherein the radio transceiver is further configured to transmit from the network node to the mobile terminal on the selected one of the plurality of frequency bands allocated for cooperative downlink transmission at the predetermined frequency band transmission power level of the selected frequency band.

In some embodiments, the radio transceiver is configured to transmit the network node-specific reference symbols commonly to a plurality of mobile terminals.

In some embodiments, the network node is an evolved-Node B (eNB).

In some embodiments, the radio transceiver is configured to transmit from the network node to the mobile terminal in cooperation with at least one other network node in the same frequency band of the plurality of frequency bands allocated for cooperative downlink transmission, wherein each network node has a respective predetermined frequency band transmission power level for each of the plurality of frequency bands.

In some embodiments, the radio transceiver is further configured to transmit to the mobile terminal in at least one frequency band that is not included in the plurality of frequency bands allocated for cooperative downlink transmission, wherein transmitting in the at least one frequency band that is not included in the plurality of frequency bands allocated for cooperative downlink transmission is done as a single-point transmission.

According to yet another broad aspect of the present invention, there is provided a method in a communication network, the method comprising:

cooperatively transmitting from each of a plurality of network nodes to a mobile terminal in a selected one of a plurality of frequency bands allocated for cooperative downlink transmission, wherein each network node has a respective predetermined frequency band transmission power level for each of the plurality of frequency bands allocated for cooperative downlink transmission.

In some embodiments, for at least one of the frequency bands, the respective predetermined frequency band transmission power level of at least one of the network nodes is different than the respective predetermined frequency band transmission power level of at least one of the other network nodes of the plurality of network nodes.

In some embodiments, the respective predetermined frequency band transmission power levels are predetermined based on optimization of a network performance parameter.

In some embodiments, optimization of a network performance parameter comprises maximizing network throughput.

In some embodiments, the method further comprises:

for each network node of the plurality of network nodes, transmitting to the mobile terminal, for each frequency band of the plurality of frequency bands allocated for cooperative downlink transmission, an indication of the respective predetermined frequency band transmission power level used by the respective network node for the respective frequency band.

In some embodiments, the method further comprises:

receiving channel state information in respect of the mobile terminal indicative of channels between the mobile terminal and each of the plurality of network nodes for at least one of the plurality of frequency bands.

In some embodiments, cooperatively transmitting from each of the plurality of network nodes to the mobile terminal in a selected one of a plurality of frequency bands allocated for cooperative downlink transmission comprises scheduling the mobile terminal at the plurality of network nodes for cooperative downlink transmission in one of the plurality of frequency bands having regard to the channel state information and, for each frequency band of the plurality of frequency bands, the predetermined frequency band transmission power levels used by the plurality of network nodes in the frequency band.

In some embodiments, the method further comprises:

each network node of the plurality of network nodes respectively transmitting, for each of the plurality of frequency bands allocated for cooperative downlink transmission, network node-specific reference symbols at the respective predetermined frequency band transmission power level used by the network node for the respective frequency band.

In some embodiments, the method further comprises determining the channel state information at the mobile terminal by:

for each network node, determining channel state information indicative of a channel between the network node and the mobile terminal for each of the at least one of the plurality of frequency bands based on: the indication of the respective predetermined frequency band transmission power level used by the respective network node for the respective frequency band and the network node-specific reference symbols transmitted by the respective network node in the respective frequency band.

In some embodiments, the plurality of network nodes comprises network nodes in adjacent cells.

In some embodiments, the network nodes in adjacent cells comprise evolved-Node Bs (eNBs) of adjacent sites in the communication network.

According to still another broad aspect of the present invention, there is provided a mobile terminal comprising:

a radio transceiver configured to receive cooperative downlink transmissions from each of a plurality of network nodes in a selected one of a plurality of frequency bands allocated for cooperative downlink transmission, wherein each network node has a respective predetermined frequency band transmission power level for each of the plurality of frequency bands allocated for cooperative downlink transmission.

In some embodiments, for at least one of the frequency bands, the respective predetermined frequency band transmission power level of at least one of the network nodes is different than the respective predetermined frequency band transmission power level of at least one of the other network nodes of the plurality of network nodes.

In some embodiments, the respective predetermined frequency band transmission power levels are predetermined based on optimization of a network performance parameter.

In some embodiments, optimization of a network performance parameter comprises maximizing network throughput.

In some embodiments, the radio transceiver is further configured to:

receive, for each network node of the plurality of network nodes, for each frequency band of the plurality of frequency bands allocated for cooperative downlink transmission, an indication of the respective predetermined frequency band transmission power level used by the respective network node for the respective frequency band.

In some embodiments, the radio transceiver is further configured to:

receive, from each network node of the plurality of network nodes, for each of the plurality of frequency bands allocated for cooperative downlink transmission, network node-specific reference symbols at the respective predetermined frequency band transmission power level used by the network node for the respective frequency band.

In some embodiments, the mobile terminal further comprises a processor configured to determine channel state information indicative of channels between the mobile terminal and each of the plurality of network nodes for at least one of the plurality of frequency bands based on: the indication of the respective predetermined frequency band transmission power level used by the respective network node for the respective frequency band and the network node-specific reference symbols transmitted by the respective network node in the respective frequency band.

In some embodiments, the radio transceiver is further configured to transmit the channel state information to one or more of the plurality of network nodes.

In some embodiments, the radio transceiver is configured to receive cooperative downlink transmissions from the plurality of network nodes on one of the plurality of frequency bands based on the channel state information and, for each frequency band of the plurality of frequency bands, the predetermined frequency band transmission power levels used by the plurality of network nodes in the frequency band.

In some embodiments, the radio transceiver is further configured to receive a scheduling to the selected one of the plurality of frequency bands.

In some embodiments, the mobile terminal further comprises:

a memory configured to store information identifying, for each of the plurality of network nodes, the network node's respective predetermined frequency band transmission power level for each of the plurality of frequency bands allocated for cooperative downlink transmission; and

a processor configured to determine, for the selected one of the plurality of frequency bands allocated for cooperative downlink transmission, the respective predetermined frequency band transmission power level of each of the plurality of network nodes based on the stored information.

According to a further broad aspect of the present invention, there is provided a method in a communication network, the method comprising:

in respect of a plurality of frequency bands allocated for cooperative downlink transmission, for which, for each band a respective plurality of predetermined frequency band transmission power levels is used respectively by a plurality of network nodes for cooperative downlink transmission in the frequency band:

receiving channel state information in respect of a mobile terminal indicative of channels between the mobile terminal and each of the plurality of network nodes for at least one of the plurality of frequency bands; and

scheduling the mobile terminal at two or more network nodes of the plurality of network nodes for cooperative downlink transmission in one of the plurality of frequency bands having regard to the channel state information and, for each of the plurality of frequency bands, the respective plurality of predetermined frequency band transmission power levels used respectively by the plurality of network nodes.

In some embodiments, the method further comprises:

cooperatively transmitting downlink to the mobile terminal from the two or more network nodes of the plurality of network nodes in the one of the plurality of frequency bands allocated for cooperative downlink transmission in which the mobile terminal has been scheduled.

In some embodiments, for at least one of the frequency bands, the plurality of predetermined frequency band transmission power levels used respectively by the plurality of network nodes for that frequency band are non-identical.

In some embodiments, scheduling the mobile terminal at two or more network nodes of the plurality of network nodes for cooperative downlink transmission in one of the plurality of frequency bands comprises scheduling the mobile terminal for cooperative downlink transmission at each of the network nodes.

In some embodiments, in respect of the plurality of frequency bands, the respective plurality of predetermined transmission power levels used respectively by the plurality of network nodes are predetermined based on optimization of a network performance parameter.

In some embodiments, optimization of a network performance parameter comprises maximizing network throughput.

In some embodiments, scheduling the mobile terminal at two or more network nodes of the plurality of network nodes comprises:

scheduling the mobile terminal at the two or more network nodes on one of the plurality of frequency bands allocated for cooperative downlink transmission having regard to the channel state information and, for each of the plurality of frequency bands, the respective plurality of predetermined frequency band transmission power levels used respectively by the plurality of network nodes.

In some embodiments, the method further comprises:

for each frequency band of the plurality of frequency bands allocated for cooperative downlink transmission, transmitting to the mobile terminal an indication of the respective plurality of predetermined frequency band transmission power levels used respectively by the plurality of network nodes for the respective frequency band.

In some embodiments, the method further comprises:

each network node of the plurality of network nodes respectively transmitting, for each of the plurality of frequency bands allocated for cooperative downlink transmission, network node-specific reference symbols at the respective predetermined frequency band transmission power level used by the network node for the respective frequency band.

In some embodiments, transmitting, for each of the plurality of frequency bands allocated for cooperative downlink transmission, a set of network node-specific reference symbols comprises transmitting the network node-specific reference symbols commonly to each of a plurality of mobile terminals inclusive of the previously recited mobile terminal.

In some embodiments, the plurality of network nodes comprises network nodes in adjacent cells.

In some embodiments, the network nodes in adjacent cells comprise evolved-Node Bs (eNBs) of adjacent sites in the communication network.

Other aspects and features of the present invention will become apparent, to those ordinarily skilled in the art, upon review of the following description of the specific embodiments of the invention.

### BRIEF DESCRIPTION OF THE DRAWINGS

Embodiments of the present invention will now be described, by way of example only, with reference to the accompanying drawing figures, wherein:

FIG. 1 is a block diagram of a cellular communication system;

FIG. 2 is a block diagram of an example base station that might be used to implement some embodiments of the present invention;

FIG. 3 is a block diagram of an example wireless terminal that might be used to implement some embodiments of the present invention;

FIG. 4 is a block diagram of an example relay station that might be used to implement some embodiments of the present invention;

FIG. 5 is a block diagram of a logical breakdown of an example OFDM transmitter architecture that might be used to implement some embodiments of the present invention;

FIG. 6 is a block diagram of a logical breakdown of an example OFDM receiver architecture that might be used to implement some embodiments of the present invention;

FIG. 7A is a block diagram of a SC-FDMA transmitter;

FIG. 7B is a block diagram of a SC-FDMA receiver;

FIG. 8 is a diagram of a site and cell architecture in accordance with an embodiment of the present invention;

FIG. 9 is a graph showing, for various power allocation techniques, the fraction of mobile terminals that experience no more than a given Signal-to-Interference and Noise Ratio (SINR);

FIG. 10 is a graph showing, for various power allocation techniques, the fraction of mobile terminals receiving no more than a given data rate;

FIG. 11 is a diagram showing the predetermined frequency band transmission power levels of three network nodes for each of four frequency bands allocated for cooperative downlink transmission in accordance with an embodiment of the present invention;

FIG. 12 is a graph showing, for various power allocation techniques, the fraction of mobile terminals that experience no more than a given SINR;

FIG. 13 is a graph showing, for various power allocation techniques, the fraction of mobile terminals receiving no more than a given data rate;

FIG. 14 is a graph showing, for various power allocation techniques, the fraction of mobile terminals that experience no more than a given SINR; and

FIG. 15 is a graph showing, for various power allocation techniques, the fraction of mobile terminals receiving no more than a given data rate.

### DETAILED DESCRIPTION

In the following detailed description of sample embodiments, reference is made to the accompanying drawings, which form a part hereof, and in which is shown by way of illustration specific sample embodiments in which the present invention may be practised. These embodiments are described in sufficient detail to enable those skilled in the art to practice the invention, and it is to be understood that other embodiments may be utilized and that logical, mechanical, electrical, and other changes may be made without departing from the scope of the invention. The following detailed description is, therefore, not to be taken in a limiting sense, and the scope is defined by the appended claims.

As noted above, Coordinated multiple point (COMP) transmission/reception has been proposed for LTE-A to address the ICI problem and to improve coverage and increase cell-edge and aggregate system throughputs. Also as noted above coordination among all network nodes in a system requires high backhaul capacity and in some cases may be too complex to implement. To reduce the complexity, cooperation among a limited number (cluster) of network nodes for communicating with a particular mobile terminal (UE) may be considered.

Methods are provided herein that include the scheduling of a mobile terminal at two or more cooperating network nodes in one of a plurality of frequency bands allocated for cooperative downlink transmission, wherein each of the cooperating network nodes has its own predetermined frequency band transmission power level for each of the frequency bands.

Embodiments of the present invention provide techniques for power allocation among network nodes in a communication network for CoMP downlink transmission. Proper power allocation among network nodes in a cluster can minimize the total power of the network nodes in the cluster for a given rate delivered to a UE in the CoMP zone, or equivalently, minimize inter-cluster interference. The selection of one of the frequency bands for cooperative downlink transmission to a mobile terminal can be made on the basis of minimizing the total power of the network nodes in the cluster for a given rate delivered to a mobile terminal in the frequency bands allocated for cooperative downlink transmission, or equivalently, minimizing inter-cluster interference.

That is, for example, supposing that a mobile terminal is closer to one of two cooperating network nodes and a given rate must be delivered to the mobile terminal, then, in some embodiments, in order to minimize the total power of the cooperating network nodes for cooperative downlink transmission to the mobile terminal, and thus minimize the interference on the rest of the network, a frequency band among the plurality of frequency bands allocated for cooperative downlink transmission may be selected in which the predetermined frequency band transmission levels of the cooperating network nodes are such that the network node that is closer to the mobile terminal is allocated more transmission power than the farther one of the two network nodes. In some embodiments, this selection of frequency band is based on channel state information reported by the mobile terminal.

The use of predetermined frequency band transmission power levels can potentially avoid the need for UE-specific reference symbols in channel estimation, as described herein.

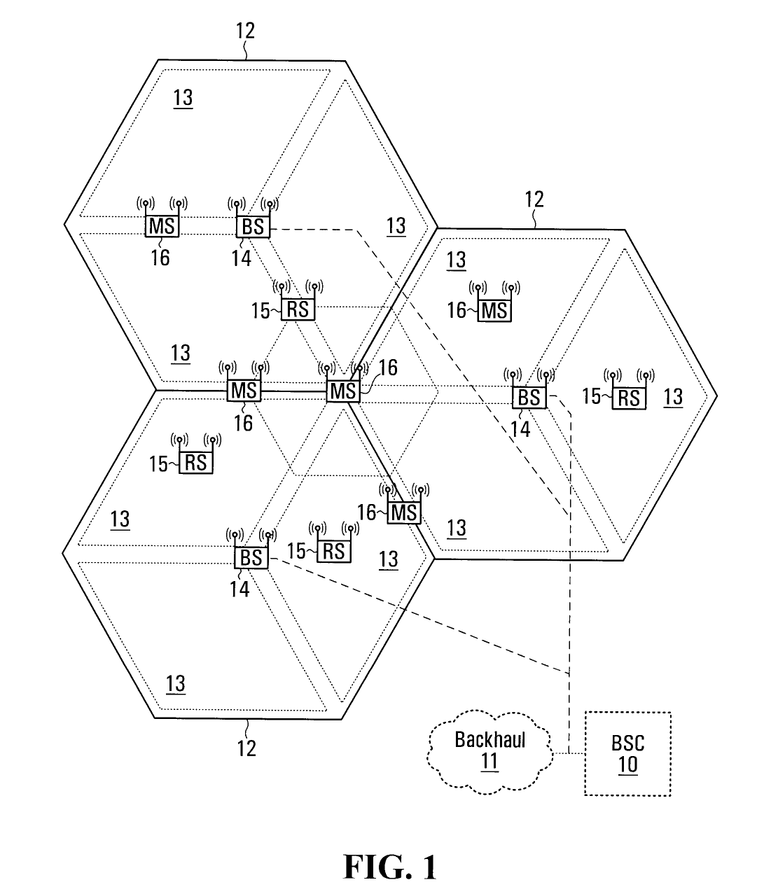

Reference will now be made to FIGS. 1-6, 7A and 7B, which illustrate various examples of networks, network nodes and mobile terminals in which embodiments of the present invention may be realized.

Referring first to FIG. 1, FIG. 1 shows a base station controller (BSC) 10 which controls wireless communications within multiple cells 12, which cells are served by corresponding base stations (BS) 14. In some configurations, each cell is further divided into multiple sectors 13 or zones (not shown). In general, each base station 14 facilitates communications using OFDM with 20 mobile and/or wireless terminals 16, which are within the cell 12 associated with the corresponding base station 14. The movement of the mobile terminals 16 in relation to the base stations 14 results in significant fluctuation in channel conditions. As illustrated, the base stations 14 and mobile terminals 16 may include multiple antennas to provide spatial diversity for communications. In 3 some configurations, relay stations 15 may assist in communications between base stations 14 and wireless terminals 16. Wireless terminals 16 can be handed off 18 from any cell 12, sector 13, zone (not shown), base station 14 or relay 15 to an other cell 12, sector 13, zone (not shown), base station 14 or relay 15. In some configurations, base stations 14 communicate with each and with another network (such as a core network or the internet, both not shown) over a backhaul network 11. In some configurations, a base station controller 10 is not needed.

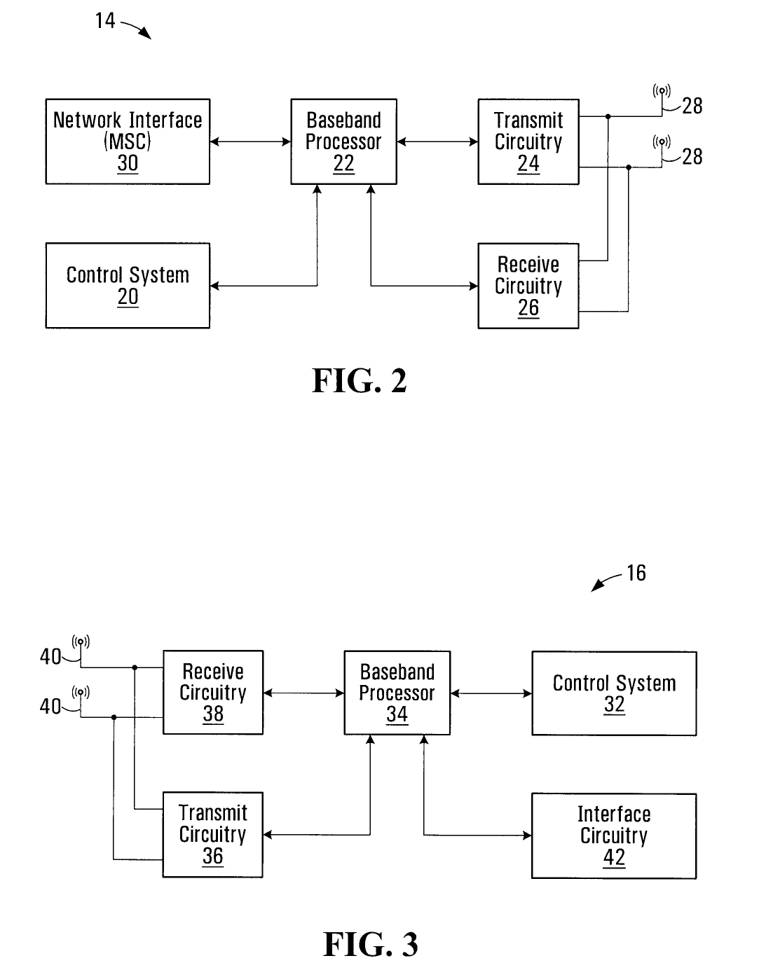

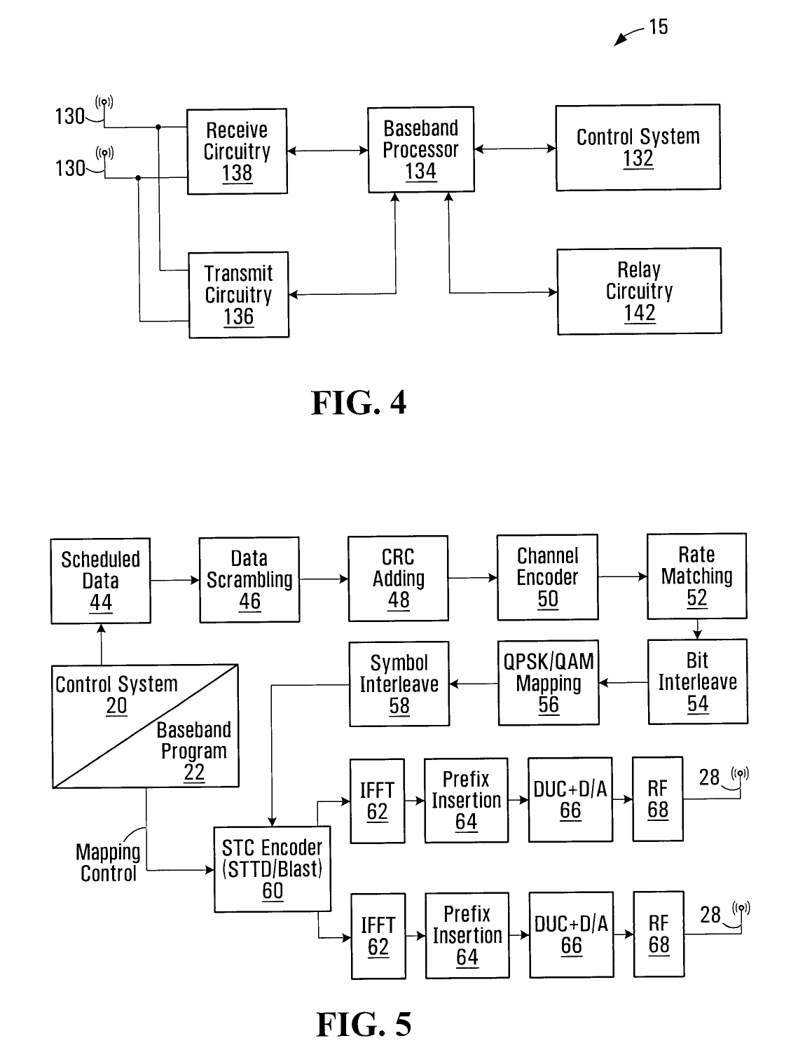

With reference to FIG. 2, an example of a base station 14 is illustrated. The base station 14 generally includes a control system 20, a baseband processor 22, transmit circuitry 24, receive circuitry 26, multiple antennas 28, and a network interface 30. The receive circuitry 26 receives radio frequency signals bearing information from one or more remote transmitters provided by mobile terminals 16 (illustrated in FIG. 3) and relay stations 15 (illustrated in FIG. 4). A low noise amplifier and a filter (not shown) may cooperate to amplify and remove broadband interference from the signal for processing. Downconversion and digitization circuitry (not shown) will then downconvert the filtered, received signal to an intermediate or baseband frequency signal, which is then digitized into one or more digital streams.

The baseband processor 22 processes the digitized received signal to extract the information or data bits conveyed in the received signal. This processing typically comprises demodulation, decoding, and error correction operations. As such, the baseband processor 22 is generally implemented in one or more digital signal processors (DSPs) or application-specific integrated 20 circuits (ASICs). The received information is then sent across a wireless network via the network interface 30 or transmitted to another mobile terminal 16 serviced by the base station 14, either directly or with the assistance of a relay 15.

On the transmit side, the baseband processor 22 receives digitized data, which may represent voice, data, or control information, from the network interface 30 under the control of control system 20, and encodes the data for transmission. The encoded data is output to the transmit circuitry 24, where it is modulated by one or more carrier signals having a desired transmit frequency or frequencies. A power amplifier (not shown) will amplify the modulated carrier signals to a level appropriate for transmission, and deliver the modulated carrier signals to the antennas 28 through a matching network (not shown). Modulation and processing details are described in greater detail below.

With reference to FIG. 3, an example of a mobile terminal 16 is illustrated. Similarly to the base station 14, the mobile terminal 16 will include a control system 32, a baseband processor 34, transmit circuitry 36, receive circuitry 38, multiple antennas 40, and user interface circuitry 42. The receive circuitry 38 receives radio frequency signals bearing information from one or more base stations 14 and relays 15. A low noise amplifier and a filter (not shown) may cooperate to amplify and remove broadband interference from the signal for processing. Downconversion and digitization circuitry (not shown) will then downconvert the filtered, received signal to an intermediate or baseband frequency signal, which is then digitized into one or more digital streams.

The baseband processor 34 processes the digitized received signal to extract the information or data bits conveyed in the received signal. This processing typically comprises demodulation, decoding, and error correction operations. The baseband processor 34 is generally implemented in one or more digital signal processors (DSPs) and application specific integrated circuits (ASICs).

For transmission, the baseband processor 34 receives digitized data, which may represent voice, video, data, or control information, from the control system 32, which it encodes for 20 transmission. The encoded data is output to the transmit circuitry 36, where it is used by a modulator to modulate one or more carrier signals that is at a desired transmit frequency or frequencies. A power amplifier (not shown) will amplify the modulated carrier signals to a level appropriate for transmission, and deliver the modulated carrier signal to the antennas 40 through a matching network (not shown). Various modulation and processing techniques available to those skilled in the art are used for signal transmission between the mobile terminal and the base station, either directly or via the relay station.

In OFDM modulation, the transmission band is divided into multiple, orthogonal carrier waves. Each carrier wave is modulated according to the digital data to be transmitted. Because OFDM divides the transmission band into multiple carriers, the bandwidth per carrier decreases and the modulation time per carrier increases. Since the multiple carriers are transmitted in parallel, the transmission rate for the digital data, or symbols, on any given carrier is lower than when a single carrier is used.

OFDM modulation utilizes the performance of an Inverse Fast Fourier Transform (IFFT) on the information to be transmitted. For demodulation, the performance of a Fast Fourier Transform (FFT) on the received signal recovers the transmitted information. In practice, the IFFT and FFT are provided by digital signal processing carrying out an Inverse Discrete Fourier Transform (IDFT) and Discrete Fourier Transform (DFT), respectively. Accordingly, the characterizing feature of OFDM modulation is that orthogonal carrier waves are generated for multiple bands within a transmission channel. The modulated signals are digital signals having a relatively low transmission rate and capable of staying within their respective bands. The individual carrier waves are not modulated directly by the digital signals. Instead, all carrier waves are modulated at once by IFFT processing.

In operation, OFDM is preferably used for at least downlink transmission from the base stations 14 to the mobile terminals 16. Each base station 14 is equipped with “n” transmit antennas 20 28 (n>=1), and each mobile terminal 16 is equipped with “m” receive antennas 40 (m>=1). Notably, the respective antennas can be used for reception and transmission using appropriate duplexers or switches and are so labelled only for clarity.

When relay stations 15 are used, OFDM is preferably used for downlink transmission from the base stations 14 to the relays 15 and from relay stations 15 to the mobile terminals 16.

With reference to FIG. 4, an example of a relay station 15 is illustrated. Similarly to the base station 14, and the mobile terminal 16, the relay station 15 will include a control system 132, a baseband processor 134, transmit circuitry 136, receive circuitry 138, multiple antennas 130, and relay circuitry 142. The relay circuitry 142 enables the relay 14 to assist in communications between a base station 16 and mobile terminals 16. The receive circuitry 138 receives radio frequency signals bearing information from one or more base stations 14 and mobile terminals 16. A low noise amplifier and a filter (not shown) may cooperate to amplify and remove broadband interference from the signal for processing. Downconversion and digitization circuitry (not shown) will then downconvert the filtered, received signal to an intermediate or baseband frequency signal, which is then digitized into one or more digital streams.

The baseband processor 134 processes the digitized received signal to extract the information or data bits conveyed in the received signal. This processing typically comprises demodulation, decoding, and error correction operations. The baseband processor 134 is generally implemented in one or more digital signal processors (DSPs) and application specific integrated circuits (ASICs).

For transmission, the baseband processor 134 receives digitized data, which may represent voice, video, data, or control information, from the control system 132, which it encodes for transmission. The encoded data is output to the transmit circuitry 136, where it is used by a modulator to modulate one or more carrier signals that is at a desired transmit frequency or 20 frequencies. A power amplifier (not shown) will amplify the modulated carrier signals to a level appropriate for transmission, and deliver the modulated carrier signal to the antennas 130 through a matching network (not shown). Various modulation and processing techniques available to those skilled in the art are used for signal transmission between the mobile terminal and the base station, either directly or indirectly via a relay station, as described above.

With reference to FIG. 5, a logical OFDM transmission architecture will be described. Initially, the base station controller 10 will send data to be transmitted to various mobile terminals 16 to the base station 14, either directly or with the assistance of a relay station 15. The base station 14 may use the channel quality indicators (CQIs) associated with the mobile terminals to schedule the data for transmission as well as select appropriate coding and modulation for transmitting the scheduled data. The CQIs may be directly from the mobile terminals 16 or determined at the base station 14 based on information provided by the mobile terminals 16. In either case, the CQI for each mobile terminal 16 is a function of the degree to which the channel amplitude (or response) varies across the OFDM frequency band.

Scheduled data 44, which is a stream of bits, is scrambled in a manner reducing the peak-to-average power ratio associated with the data using data scrambling logic 46. A cyclic redundancy check (CRC) for the scrambled data is determined and appended to the scrambled data using CRC adding logic 48. Next, channel coding is performed using channel encoder logic 50 to effectively add redundancy to the data to facilitate recovery and error correction at the mobile terminal 16. Again, the channel coding for a particular mobile terminal 16 is based on the CQI. In some implementations, the channel encoder logic 50 uses known Turbo encoding techniques. The encoded data is then processed by rate matching logic 52 to compensate for the data expansion associated with encoding.

Bit interleaver logic 54 systematically reorders the bits in the encoded data to minimize the 20 loss of consecutive data bits. The resultant data bits are systematically mapped into corresponding symbols depending on the chosen baseband modulation by mapping logic 56. Preferably, Quadrature Amplitude Modulation (QAM) or Quadrature Phase Shift Key (QPSK) modulation is used. The degree of modulation is preferably chosen based on the CQI for the particular mobile terminal. The symbols may be systematically reordered to further bolster the immunity of the transmitted signal to periodic data loss caused by frequency selective fading using symbol interleaver logic 58.

At this point, groups of bits have been mapped into symbols representing locations in an amplitude and phase constellation. When spatial diversity is desired, blocks of symbols are then processed by space-time block code (STC) encoder logic 60, which modifies the symbols in a fashion making the transmitted signals more resistant to interference and more readily decoded at a mobile terminal 16. The STC encoder logic 60 will process the incoming symbols and provide “n” outputs corresponding to the number of transmit antennas 28 for the base station 14. The control system 20 and/or baseband processor 22 as described above with respect to FIG. 5 will provide a mapping control signal to control STC encoding. At this point, assume the symbols for the “n” outputs are representative of the data to be transmitted and capable of being recovered by the mobile terminal 16.

For the present example, assume the base station 14 has two antennas 28 (n=2) and the STC encoder logic 60 provides two output streams of symbols. Accordingly, each of the symbol streams output by the STC encoder logic 60 is sent to a corresponding IFFT processor 62, illustrated separately for ease of understanding. Those skilled in the art will recognize that one or more processors may be used to provide such digital signal processing, alone or in combination with other processing described herein. The IFFT processors 62 will preferably operate on the respective symbols to provide an inverse Fourier Transform. The output of the IFFT processors 62 provides 20 symbols in the time domain. The time domain symbols are grouped into frames, which are associated with a prefix by prefix insertion logic 64. Each of the resultant signals is up-converted in the digital domain to an intermediate frequency and converted to an analog signal via the corresponding digital up-conversion (DUC) and digital-to-analog (D/A) conversion circuitry 66. The resultant (analog) signals are then simultaneously modulated at the desired RF frequency, amplified, and transmitted via the RF circuitry 68 and antennas 28. Notably, pilot signals known by the 9 intended mobile terminal 16 are scattered among the sub-carriers. The mobile terminal 16, which is discussed in detail below, will use the pilot signals for channel estimation.

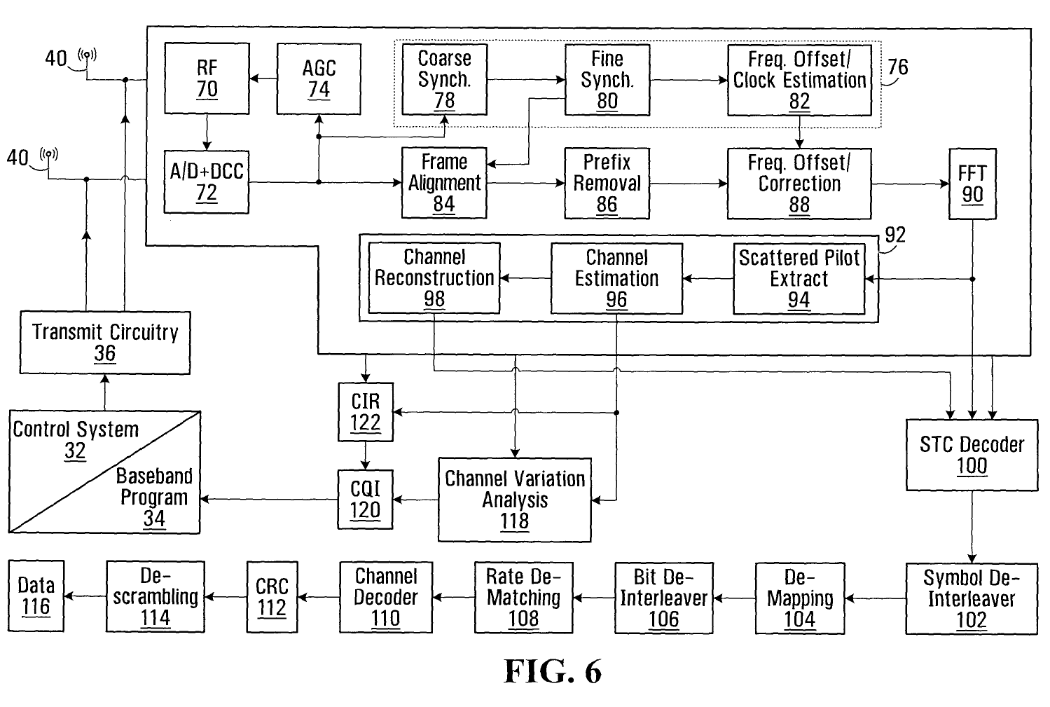

Reference is now made to FIG. 6 to illustrate reception of the transmitted signals by a mobile terminal 16, either directly from base station 14 or with the assistance of relay 15. Upon arrival of the transmitted signals at each of the antennas 40 of the mobile terminal 16, the respective signals are demodulated and amplified by corresponding RF circuitry 70. For the sake of conciseness and clarity, only one of the two receive paths is described and illustrated in detail. Analog-to-digital (A/D) converter and down-conversion circuitry 72 digitizes and downconverts the analog signal for digital processing. The resultant digitized signal may be used by automatic gain control circuitry (AGC) 74 to control the gain of the amplifiers in the RF circuitry 70 based on the received signal level.

Initially, the digitized signal is provided to synchronization logic 76, which includes coarse synchronization logic 78, which buffers several OFDM symbols and calculates an auto-correlation between the two successive OFDM symbols. A resultant time index corresponding to the maximum of the correlation result determines a fine synchronization search window, which is used by fine synchronization logic 80 to determine a precise framing starting position based on the headers. The output of the fine synchronization logic 80 facilitates frame acquisition by frame alignment logic 84. Proper framing alignment is important so that subsequent FFT processing provides an accurate conversion from the time domain to the frequency domain. The fine synchronization algorithm is 20 based on the correlation between the received pilot signals carried by the headers and a local copy of the known pilot data. Once frame alignment acquisition occurs, the prefix of the OFDM symbol is removed with prefix removal logic 86 and resultant samples are sent to frequency offset correction logic 88, which compensates for the system frequency offset caused by the unmatched local oscillators in the transmitter and the receiver. Preferably, the synchronization logic 76 includes frequency offset and clock estimation logic 82, which is based on the headers to help estimate such effects on the transmitted signal and provide those estimations to the correction logic 88 to properly process OFDM symbols.

At this point, the OFDM symbols in the time domain are ready for conversion to the frequency domain using FFT processing logic 90. The results are frequency domain symbols, which are sent to processing logic 92. The processing logic 92 extracts the scattered pilot signal using scattered pilot extraction logic 94, determines a channel estimate based on the extracted pilot signal using channel estimation logic 96, and provides channel responses for all sub-carriers using channel reconstruction logic 98. In order to determine a channel response for each of the sub-carriers, the pilot signal is essentially multiple pilot symbols that are scattered among the data symbols throughout the OFDM sub-carriers in a known pattern in both time and frequency. Continuing with FIG. 6, the processing logic compares the received pilot symbols with the pilot symbols that are expected in certain sub-carriers at certain times to determine a channel response for the sub-carriers in which pilot symbols were transmitted. The results are interpolated to estimate a channel response for most, if not all, of the remaining sub-carriers for which pilot symbols were not provided. The actual and interpolated channel responses are used to estimate an overall channel response, which includes the channel responses for most, if not all, of the sub-carriers in the OFDM channel.

The frequency domain symbols and channel reconstruction information, which are derived from the channel responses for each receive path are provided to an STC decoder 100, which provides STC decoding on both received paths to recover the transmitted symbols. The channel 20 reconstruction information provides equalization information to the STC decoder 100 sufficient to remove the effects of the transmission channel when processing the respective frequency domain symbols.

The recovered symbols are placed back in order using symbol de-interleaver logic 102, which corresponds to the symbol interleaver logic 58 of the transmitter. The de-interleaved symbols are then demodulated or de-mapped to a corresponding bitstream using de-mapping logic 104. The bits are then de-interleaved using bit de-interleaver logic 106, which corresponds to the bit interleaver logic 54 of the transmitter architecture. The de-interleaved bits are then processed by rate de-matching logic 108 and presented to channel decoder logic 110 to recover the initially scrambled data and the CRC checksum. Accordingly, CRC logic 112 removes the CRC checksum, checks the scrambled data in traditional fashion, and provides it to the de-scrambling logic 114 for descrambling using the known base station de-scrambling code to recover the originally transmitted data 116.

In parallel to recovering the data 116, a CQI, or at least information sufficient to create a CQI at the base station 14, is determined and transmitted to the base station 14. As noted above, the CQI may be a function of the carrier-to-interference ratio (CR), as well as the degree to which the channel response varies across the various sub-carriers in the OFDM frequency band. For this embodiment, the channel gain for each sub-carrier in the OFDM frequency band being used to transmit information is compared relative to one another to determine the degree to which the channel gain varies across the OFDM frequency band. Although numerous techniques are available to measure the degree of variation, one technique is to calculate the standard deviation of the channel gain for each sub-carrier throughout the OFDM frequency band being used to transmit data.

In some embodiments, SC-FDMA (Single-Carrier Frequency Division Multiple Access) is used. SC-FDMA is a modulation and multiple access scheme introduced for the uplink of 3GPP Long Term Evolution (LTE) broadband wireless fourth generation (4G) air interface standards, and the like. SC-FDMA can be viewed as a DFT pre-coded OFDMA scheme, or, it can be viewed as a single carrier (SC) multiple access scheme.

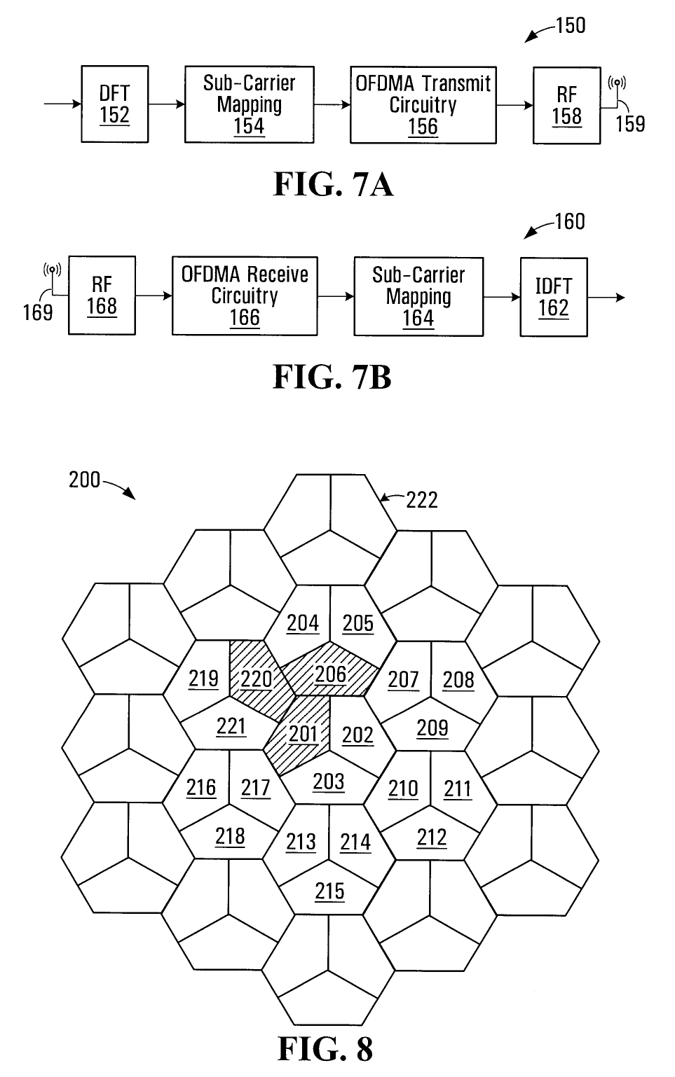

Aspects of SC-FDMA signaling are now discussed with reference to FIGS. 7A and 7B, which provide examples of a conventional SC-FDMA transmitter 150 and receiver 160 for single-in single-out (SISO) communication. In SISO, mobile stations transmit on one antenna and base stations and/or relay stations receive on one antenna. FIGS. 7A and 7B illustrate one example of signal processing steps/blocks that may be used at the transmitter and receiver for SC-FDMA signaling.

The SC-FDMA transmitter 150 illustrated in FIG. 7A includes a signal processing path that includes a DFT 152, a Sub-carrier mapper 154, OFDMA transmit circuitry 156, a radio frequency (RF) radio 158 and a transmit antenna 159.

The SC-FDMA receiver 160 illustrated in FIG. 7B includes a signal processing path that includes a receive antenna 169, an RF radio 168, OFDMA receive circuitry 166, a Sub-Carrier mapper 164 and an IDFT 162.

As noted above, the example SC-FDMA transmitter 150 and receiver 160 illustrated in FIGS. 7A and 7B are configured for single-in single-out (SISO) configuration. In SISO, mobile terminals and network nodes transmit and receive on one antenna. However, it should be understood that embodiments of the present invention are not limited to SISO operation. FIGS. 7A and 7B are provided merely as specific examples to illustrate configurations and modes of operation that may be utilized in some embodiments of the present invention.

There are several similarities in the overall transceiver processing of SC-FDMA and OFDMA. Those common aspects between OFDMA and SC-FDMA are illustrated in the OFDMA transmit circuitry 156 and OFDMA receive circuitry 166, as they would be obvious to a person having ordinary skill in the art in view of the present specification. SC-FDMA is distinctly different from OFDMA because of the DFT 152 pre-coding of the modulated symbols, and the corresponding IDFT 162 of the demodulated symbols. Because of this pre-coding, the SC-FDMA sub-carriers are not independently modulated as in the case of the OFDMA sub-carriers. As a result, the peak to average power ratio (PAPR) of SCFDMA signaling is lower than the PAPR of OFDMA signaling, which means that the transmit power efficiency of SC-FDMA is generally higher than that of OFDMA signaling.

FIGS. 1 to 6, 7A and 7B provide specific examples of communication systems and components thereof that could be used to implement embodiments of the present invention. It is to be understood that embodiments of the present invention can be implemented with communications systems having architectures that are different than the specific examples discussed above, but that operate in a manner consistent with the implementation of the embodiments as described herein.

Referring now to FIG. 8, FIG. 8 is a diagram showing an exemplary arrangement of sites 222, each divided into three cells, in a cellular communication network 200 in accordance with an embodiment of the present invention. In FIG. 8, only 21 cells 201-221 of seven adjacent sites are explicitly identified.

Consider the fixed cluster highlighted in FIG. 8, which consists of adjacent cells 201, 206 and 220, where three network nodes in cells 201, 206, and 220 are assumed to cooperate in the joint processing mode to transmit to a UE in the cluster scheduled in a CoMP frequency zone allocated for CoMP downlink transmission.

With a total power constraint on network nodes (in a frequency band where the UE may be scheduled), the optimal power allocation among network nodes to achieve the highest transmission rate may be obtained, for example, by a waterfilling algorithm after singular value decomposition (SVD) of the composite channel matrix from network nodes to the UE. In other words, for a given rate delivered to the UE, less total power is required if a proper power allocation algorithm is chosen. The waterfilling algorithm is a known method of power assignment to parallel channels, and is described in further detail in, for example, T. M. Cover and J. A. Thomas, “Elements of Information Theory”, John Wiley & Sons, Inc, 1991, which is hereby incorporated by reference in its entirety.

For convenience, in the following explanation we will consider single-antenna network nodes and UEs. However, please note that, more generally, embodiments of the present invention may include any number of receive and transmit antennas, and are by no means to be considered to be limited to the very specific examples described herein.

Let hᵢ be the channel gain from network node i to the UE and P be the total power of network nodes in the frequency band in which a UE is scheduled. The transmitted signal from network nodes corresponding to optimal power allocation is given by

$${x}_{i} = \frac{{h}_{i}^{*}}{‖ h ‖} s , i = 201 , 206 , 220 , \qquad ( 1 )$$

where h=[h₂₀₁ h₂₀₆ h₂₂₀] and E[|s|²]=P. As it can be seen from (1), the power allocated to network node i is proportional to |hᵢ|². The corresponding SINR and rate received by the UE are given by

$$\begin{matrix}{SIN R}_{1} = \frac{{‖ h ‖}^{2} P}{N} , & ( 2 ) \\ {R}_{1} = \frac{1}{3} log ( 1 + \frac{{‖ h ‖}^{2} P}{N} ) , & ( 3 )\end{matrix}$$

where N is the sum of the noise power and the interference from the other clusters. The factor ⅓ is included in the rate calculation to take into account that three network nodes are used for transmission.

The transmitted signal corresponding to equal power allocation is given by

$${X}_{i} = \frac{{h}_{i}^{*}}{\sqrt{3} \vert {h}_{i} \vert} s , i = 201 , 206 , 220. \qquad ( 4 )$$

The corresponding SINR and rate received by the UE are given by

$$\begin{matrix}{SIN R}_{2} = \frac{{( \vert {h}_{201} \vert + \vert {h}_{206} \vert + \vert {h}_{220} \vert )}^{2} P}{3 N} , & ( 5 ) \\ {R}_{2} = \frac{1}{3} log ( 1 + \frac{{( \vert {h}_{201} \vert + \vert {h}_{206} \vert + \vert {h}_{220} \vert )}^{2} P}{3 N} ) . & ( 6 )\end{matrix}$$

In order to compare the performances with optimal power allocation and equal power allocation, we consider the cellular system shown in FIG. 8 with 57 cells (19 sites divided into three cells each). For simulation purposes, UEs are distributed uniformly in the highlighted cluster that includes cells 201, 206 and 220. Only low geometry UEs (those to be served in CoMP frequency zone) are considered in the simulations. For the purposes of this simulation, UEs distributed in cells 201, 206 and 220 are selected for CoMP downlink transmission based on a comparision of post-CoMP rate (R⁺), i.e. the data rate a UE would receive under CoMP downlink transmission, with pre-CoMP rate (R⁻), i.e. the data rate a UE would receive under non-CoMP downlink transmission. If for a given UE, R⁺>R⁻, then the UE is selected to be served under CoMP downlink transmission. With this criteria, it turns out that under the simulated conditions described above 21% of the UEs distributed in cells 201, 206 and 220 are served in the CoMP frequency zone. The details of simulation parameters are listed in Table 1.

TABLE 1
Simulation parameters

| Parameters | Assumptions | |
|---|---|---|
| BS total Tx power | 46 | dBm |
| ISD | 500 | m |
| Carrier frequency | 2 | GHz |
| Minimum distance between UE and network node | 30 | m |
| Shadowing standard deviation | 8 | dB |
| Shadowing correlation between sites | 0.5 | |
| Shadowing correlation between sectors | 1 | |
| Bs antenna gain | 15 | dBi |
| UE antenna gain | 0 | dBi |

| | |
|---|---|
| Channel model | Rayleigh fading |

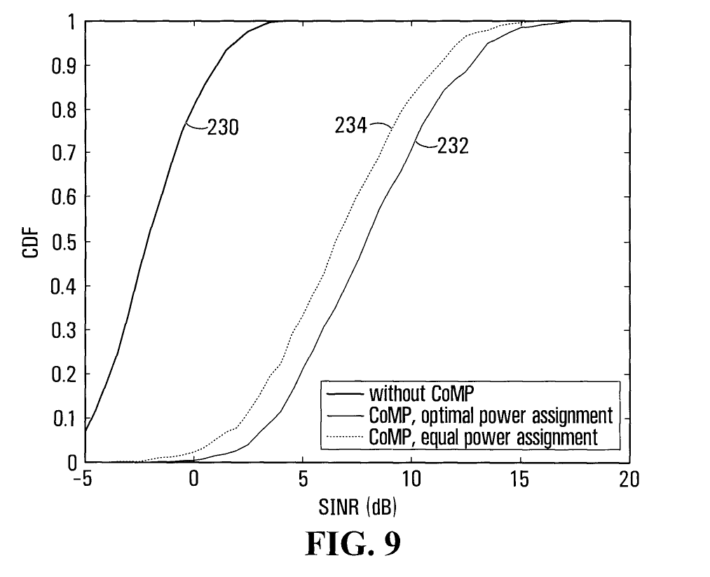

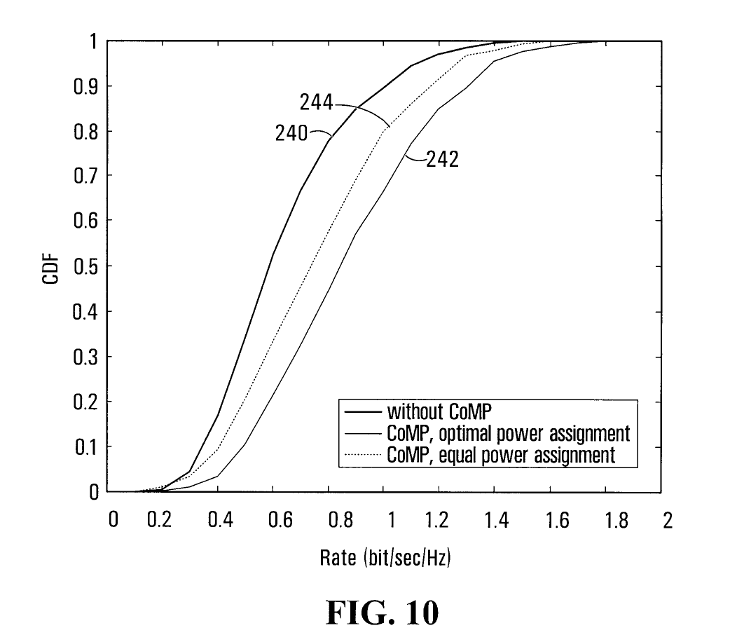

FIGS. 9 and 10 illustrate the SINR and rate geometries for optimal and equal power allocations among cooperating network nodes for CoMP downlink transmission in a CoMP frequency zone allocated for CoMP downlink transmission, as well as the corresponding simulated result for non-CoMP downlink transmission, i.e. single-point downlink transmission.

With reference to FIG. 9, FIG. 9 shows the SINR geometries for mobile terminals without CoMP 230, with optimal power assignment 232 and with equal power assignment 234, as described above. Similarly, FIG. 10 shows the rate geometries for mobile terminals without ComP 240, with optimal power assignment 242 and with equal power assignment 244, as described above. As can be seen clearly from the results of FIGS. 9 and 10, the use of CoMP improves the SINR and rate geometries compared to those for non-CoMP operation.

Optimal power allocation among different cooperating network nodes in a frequency band can be obtained through maximization of the downlink data rate of a mobile terminal for a fixed total power. In other words, for a given data rate, optimal power allocation is done to minimize the total power of the cooperating network nodes in a frequency band. However, one unfortunate drawback of optimal power allocation is that it can potentially result in different network node power levels in different subbands of the CoMP frequency zone. That is, in optimal power allocation, the optimal power levels can take any value in a continuo set. Having infinitely many power levels requires dedicated mobile terminal-specific reference symbols for channel estimation at each mobile terminal, which can increases the overhead of the system significantly.

The simple equal power allocation technique described above offers an improvement over non-CoMP operation, as shown in FIGS. 9 and 10, and does not require mobile terminal-specific reference symbols, but causes more interference to neighboring cells for a given mobile terminal throughput.

Some embodiments of the present invention provide power allocation techniques that avoid the need for mobile terminal-specific reference signals, while offering improved performance relative to non-CoMP operation and simple equal power allocation operation. In accordance with these embodiments, a plurality of frequency bands are allocated for cooperative downlink transmission, and a plurality of network nodes that might offer CoMP downlink transmission are configured such that for each frequency band of the plurality of frequency bands allocated for cooperative downlink transmission, they each have a predetermined frequency band transmission power level. In some embodiments, the respective predetermined frequency band transmission power levels of the network nodes in each frequency band is sent to the mobile terminal scheduled in the same frequency band by the serving network nodes.

The assignment of the predetermined frequency band transmission power levels among network nodes in a frequency band is done according to optimization of a network operating parameter, such as maximizing cluster throughput. In some embodiments, a mobile terminal to be served under CoMP downlink transmission is scheduled in a frequency band of the plurality of frequency bands that is expected to yield the highest data rate for the mobile terminal, i.e. maximize throughput to the mobile terminal.

There will generally be some performance degradation relative to optimal power allocation operation by forcing the network node power levels to be limited to the pre-determined frequency band transmission power levels in the plurality of frequency bands allocated for cooperative downlink transmission.

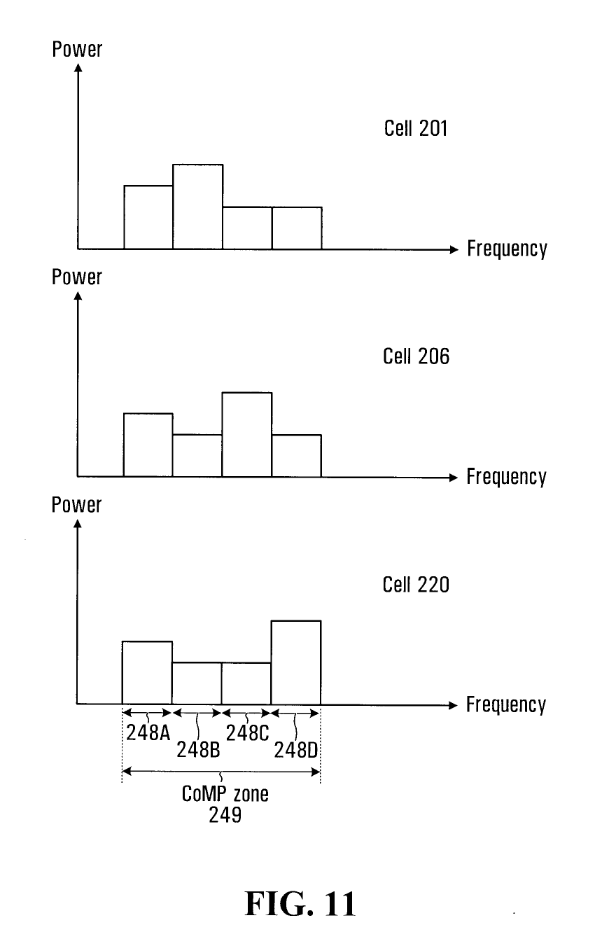

FIG. 11 illustrates an example of how four frequency bands may be allocated within a CoMP frequency zone with different predetermined network node power levels for the three clustered cells 201, 206 and 220 shown in FIG. 8.

In FIG. 11, the network nodes of cells 201, 206 and 202 each has a respective predetermined frequency band transmission power level for each of the four frequency bands 248A, 248B, 248C and 248D allocated for cooperative downlink transmission in CoMP zone 249. In the illustrated example, the respective predetermined frequency band transmission power levels for the network nodes in cells 201, 206 and 220 are equal in frequency band 248A, while in each of frequency bands 248B, 248C and 248D one of the respective network nodes has a higher predetermined frequency band transmission power level while the other two network nodes have an equal and lesser predetermined frequency band transmission power level. Specifically, the network node in cell 201 has the higher power level in frequency band 248B, the network node in cell 206 has the higher power level in frequency band 248C and the network node in cell 220 has the higher power level in frequency band 248D.

In some embodiments, it would be expected that a mobile terminal to be served under CoMP downlink transmission that is approximately equidistant to the network nodes in cells 201, 206 and 220 would be scheduled on frequency band 248A, where each network node has an equal predetermined transmission power level, while a mobile terminal to be served under CoMP downlink transmission that is closer to the network node of one of the cells than they are the network nodes of the other two would be scheduled on the frequency band for which the network node that they are closer to has the higher predetermined transmission power level. In some embodiments, the scheduling of a mobile terminal on one of the plurality of frequency bands allocated for cooperative downlink transmission is based on channel state information reported by the mobile terminal indicative of channels between the mobile terminal and each of the plurality of network nodes for each of the plurality of frequency bands.

In some cases, the bandwidths of the frequency bands allocated for cooperative downlink transmission is determined according to a statistical distribution of mobile terminal channel parameters. That is, depending on the statistical distribution of mobile terminal channel parameters, some frequency bands may have more mobile terminals scheduled in them, compared to the other frequency bands. Accordingly, the bandwidth of a frequency band allocated for cooperative downlink transmission may be selected on the basis of the number of mobile terminals that are expected to be scheduled in the frequency band based on the real or expected statistical distribution of mobile terminal channel parameters.

While FIG. 11 shows four frequency bands allocated for cooperative downlink transmission, more generally any number N of frequency bands, N>1, may be used in some embodiments of the present invention. Also, it should be noted that although the frequency bands 248A, 248B, 248C and 248D in FIG. 11 are shown as being contiguous, other arrangements of frequency bands allocated for cooperative downlink transmission may be utilized in some embodiments of the present invention.

In some embodiments in which the frequency bands allocated for cooperative downlink transmission are contiguous or nearly contiguous, a mobile terminal may only estimate a channel between the mobile terminal and a network node for one of the plurality of frequency bands. The assumption being that the channel does not change significantly for the other frequency bands. That is, in some embodiments, the mobile terminal does not estimate a channel for each frequency band.

In some embodiments, a mobile terminal may estimate a channel between the mobile terminal and a network node for one of the plurality of frequency bands allocated for cooperative downlink transmission, and then use Sounding Reference Signals (SRS) to estimate the channels for each of the other frequency bands of the plurality of frequency bands allocated for cooperative downlink transmission. This approach may be particularly useful in embodiments in which the plurality of frequency bands allocated for cooperative downlink transmission are non-contiguous.

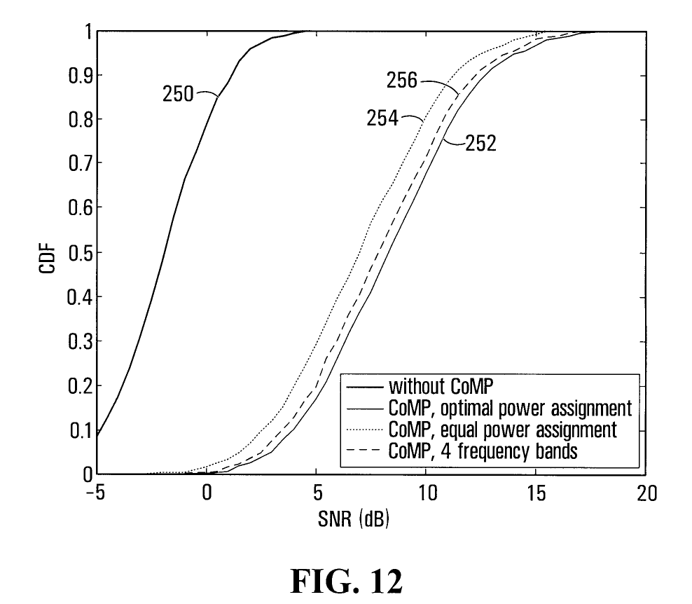

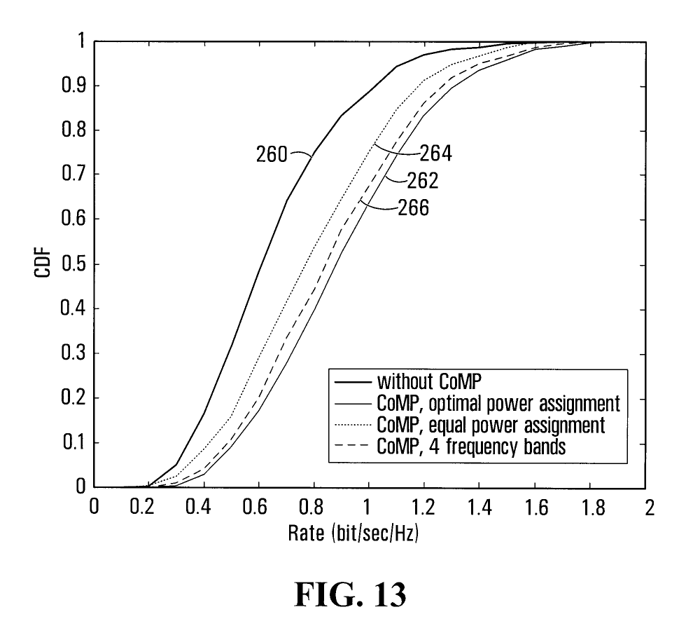

The simulated SINR and rate geometries of the predetermined power allocation technique shown in FIG. 11 are illustrated in FIGS. 12 and 13. For simulation purposes, the respective predetermined frequency band transmission power levels of the three network nodes in cells 201, 206 and 220 for each of the four frequency bands 248A, 248B, 248C and 248D have been selected as

$$( \frac{P}{3} , \frac{P}{3} , \frac{P}{3} ) , ( \frac{2 P}{3} , \frac{P}{6} , \frac{P}{6} ) , ( \frac{P}{6} , \frac{2 P}{3} , \frac{P}{6} ) , and ( \frac{P}{6} , \frac{P}{6} , \frac{2 P}{3} ) ,$$

respectively. The elements in the vectors are the respective predetermined frequency band transmission power levels of the three network nodes in cells 201, 206 and 220 for each frequency band. It should be noted that for comparison purposes with the performance of non-COMP operation, optimal power allocation, and equal power allocation, the sum power in each frequency band is the same (P). Mobile terminals that have been uniformly distributed throughout cells 201, 206 and 220 and that have met the criteria to receive cooperative downlink transmission are scheduled in one of the four frequency bands according to their channel realization.

When a mobile terminal is first switched on and/or when the mobile terminal first enters an area in which cooperative downlink transmission from a plurality of network nodes is possible, the mobile terminal may first be scheduled on one of the plurality of frequency bands allocated for cooperative downlink transmission at each of the network nodes for the purposes of initially estimating a channel between the mobile terminal and each of the network nodes. This initial scheduling may be based on any suitable criteria or it may be arbitrary and/or random. Once a channel has been estimated on the initially scheduled frequency band for each of the network nodes, and the channel state information (CSI) indicative of the channel estimate has been reported to the network, the mobile terminal is scheduled on one of the plurality of frequency bands allocated for cooperative downlink transmission based on the reported CSI and, for each frequency band, the plurality of predetermined frequency band transmission power levels corresponding respectively to the plurality of network nodes.

With reference to FIG. 12, FIG. 12 shows the SINR geometries for mobile terminals without CoMP 250, with optimal power assignment 252, with equal power assignment 254 and with scheduling in one of four frequency bands with predetermined frequency band transmission power levels 256, as described above. Similarly, FIG. 13 shows the rate geometries for mobile terminals without CoMP 260, with optimal power assignment 262, with equal power assignment 264, and with scheduling in one of four frequency bands with predetermined frequency band transmission power levels 266, as described above. As can be seen clearly from the results of FIGS. 12 and 13, the use of predetermined frequency band transmission power levels in four frequency bands improves the SINR and rate geometries compared to simple equal power allocation operation, but experiences a degradation relative to optimal power allocation.

Improved SINR and rate performance can be achieved by increasing the number of frequency bands allocated for cooperative downlink transmission in the CoMP frequency zone, although this is done at the expense of additional signalling overhead to provide the power level information to the mobile terminals for each of the frequency bands.

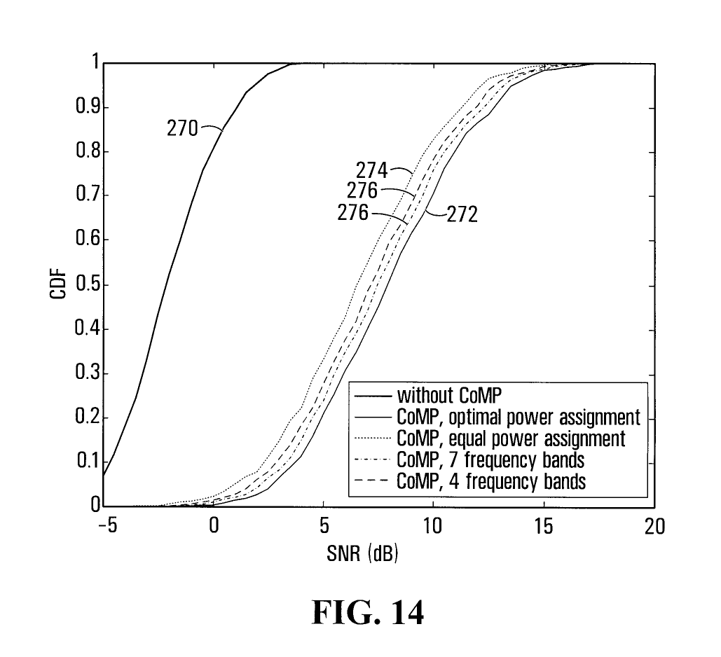

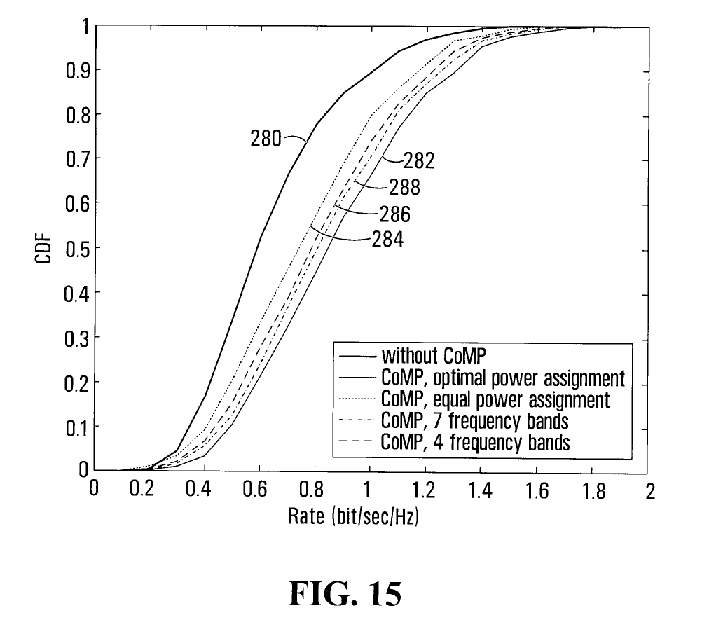

FIGS. 14 and 15 show the relative performance improvement that can potentially be realized by having more frequency bands with predetermined frequency band transmission power levels at each of the cooperating network nodes.

With reference to FIG. 14, FIG. 14 shows the SINR geometries for mobile terminals without CoMP 270, with optimal power assignment 272, with equal power assignment 274, with scheduling in one of four frequency bands with predetermined frequency band transmission power levels 276, and with scheduling in one of seven frequency bands with predetermined frequency band transmission power levels 278. Similarly, FIG. 15 shows the rate geometries for mobile terminals without CoMP 280, with optimal power assignment 282, with equal power assignment 284, with scheduling in one of four frequency bands with predetermined frequency band transmission power levels 286, and with scheduling in one of seven frequency bands with predetermined frequency band transmission power levels 288. As can be seen clearly from the results of FIGS. 14 and 15, the use of seven frequency bands improves the SINR and rate geometries compared to the use of four frequency bands, and approaches optimal power allocation performance.

A fixed clustering method has been proposed in LTE-A whereby the network is divided into fixed non-intersecting coordinated clusters of network nodes and only the network nodes in the same cluster cooperate for transmission to the UEs in the cluster. From a theoretical point of view, if the optimal transmission scheme is employed at the coordinated network nodes, which in general requires simultaneous transmission from network nodes to all UEs (i.e., Coordinated Multiple Point-Multi User-Multiple Input Multiple Output CoMP-MU-MIMO operation mode), then there is throughput gain in serving both cell-centre and cell-edge UEs under CoMP transmission. However, if the coordinated network nodes only serve one UE at any given time (i.e., Coordinated Multiple Point-Single User-Multiple Input Multiple Output CoMP-SU-MIMO operation mode), then there can be throughput loss in serving cell-centre UEs under CoMP. Therefore, in some embodiments, the frequency bandwidth in each cell of a cluster is divided into two frequency zones. In the non-CoMP frequency zone, UEs are served only by the network node in their cell. In the CoMP frequency zone, UEs are served by all or some of the network nodes in the cluster. In some embodiments, the CoMP frequency zone is divided into a plurality of frequency bands allocated for cooperative downlink transmission, as described above.

In some embodiments, pre-CoMP Signal-to-Interference and Noise Ratio (SINR) is used as a measure to decide which UEs are served under CoMP transmission. A more targeted approach is used in some embodiments to compare pre-CoMP rate (R⁺) and post-CoMP rate (R⁻), which is not much more complex than SINR calculation.

The problem of power allocation among network nodes in closed-loop downlink CoMP transmission has been considered herein. The fixed cell clustering approach for CoMP transmission has been considered and it has been determined that with optimal power allocation, less total network node power in a cluster is needed compared to the case where all network nodes in the cluster use equal power, which minimizes inter-cluster interference. However, the need for mobile terminal-specific reference symbols is needed for optimal power allocation. Techniques that avoid the need for mobile terminal-specific reference symbols have been provided that utilize network node-specific reference signals for channel estimation and allocate a plurality of frequency bands for cooperative downlink transmission, wherein for each frequency band, each cooperating network node has a predetermined frequency band transmission power level.

The foregoing description includes many detailed and specific embodiments that are provided by way of example only, and should not be construed as limiting the scope of the present invention. Alterations, modifications and variations may be effected to the particular embodiments by those of skill in the art without departing from the scope of the invention, which is defined solely by the claims appended hereto.

1. (canceled)

2. (canceled)

3. (canceled)

4. (canceled)

5. (canceled)

6. (canceled)

7. (canceled)

8. (canceled)

9. A network node comprising:
a radio transceiver configured to transmit to a mobile terminal on one of a plurality of frequency bands allocated for cooperative downlink transmission, the radio transmitter having a respective predetermined frequency band transmission power level for each of the plurality of frequency bands allocated for cooperative downlink transmission.

10. The network node of claim 9, wherein the radio transceiver is further configured to transmit:
an indication of the network node's respective predetermined frequency band transmission power level for each of the plurality of frequency bands allocated for cooperative downlink transmission; and
network node specific reference symbols on each of the plurality of frequency bands allocated for cooperative downlink transmission at the respective predetermined frequency band transmission power level of the respective frequency band.

11. (canceled)

12. The network node of claim 10, wherein the radio transceiver is further configured to receive channel state information indicative of a channel between the network node and the mobile terminal for each of the plurality of frequency bands.

13. The network node of claim 12, further comprising a processor configured to select one of the plurality of frequency bands allocated for cooperative downlink transmission having regard to the channel state information, wherein the radio transceiver is further configured to transmit from the network node to the mobile terminal on the selected one of the plurality of frequency bands allocated for cooperative downlink transmission at the predetermined frequency band transmission power level of the selected frequency band;
wherein the radio transceiver is configured to transmit the network node specific reference symbols commonly to a plurality of mobile terminals.

14. (canceled)

15. (canceled)

16. The network node of claim 9, wherein the radio transceiver is configured to transmit from the network node to the mobile terminal in cooperation with at least one other network node in the same frequency band of the plurality of frequency bands allocated for cooperative downlink transmission, wherein each network node has a respective predetermined frequency band transmission power level for each of the plurality of frequency bands.

17. The network node of claim 9, wherein
the radio transceiver is further configured to transmit to the mobile terminal in at least one frequency band that is not included in the plurality of frequency bands allocated for cooperative downlink transmission, wherein transmitting in the at least one frequency band that is not included in the plurality of frequency bands allocated for cooperative downlink transmission is done as a single-point transmission.

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. A mobile terminal comprising:
a radio transceiver configured to receive cooperative downlink transmissions from each of a plurality of network nodes in a selected one of a plurality of frequency bands allocated for cooperative downlink transmission, wherein each network node has a respective predetermined frequency band transmission power level for each of the plurality of frequency bands allocated for cooperative downlink transmission.

30. (canceled)

31. (canceled)

32. (canceled)

33. The mobile terminal of claim 29, wherein the radio transceiver is further configured to:
receive, for each network node of the plurality of network nodes, for each frequency band of the plurality of frequency bands allocated for cooperative downlink transmission, an indication of the respective predetermined frequency band transmission power level used by the respective network node for the respective frequency band; and
receive, from each network node of the plurality of network nodes, for each of the plurality of frequency bands allocated for cooperative downlink transmission, network node-specific reference symbols at the respective predetermined frequency band transmission power level used by the network node for the respective frequency band.

34. (canceled)

35. The mobile terminal of claim 33, further comprising a processor configured to determine channel state information indicative of channels between the mobile terminal and each of the plurality of network nodes for at least one of the plurality of frequency bands based on: the indication of the respective predetermined frequency band transmission power level used by the respective network node for the respective frequency band and the network node-specific reference symbols transmitted by the respective network node in the respective frequency band;
wherein the radio transceiver is further configured to transmit the channel state information to one or more of the plurality of network nodes; and
wherein the radio transceiver is configured to receive cooperative downlink transmissions from the plurality of network nodes on one of the plurality of frequency bands based on the channel state information and, for each frequency band of the plurality of frequency bands, the predetermined frequency band transmission power levels used by the plurality of network nodes in the frequency band.

36. (canceled)

37. (canceled)

38. The mobile terminal of claim 29, wherein the radio transceiver is further configured to receive a scheduling to the selected one of the plurality of frequency bands, and further comprising:
a memory configured to store information identifying, for each of the plurality of network nodes, the network node's respective predetermined frequency band transmission power level for each of the plurality of frequency bands allocated for cooperative downlink transmission; and
a processor configured to determine, for the selected one of the plurality of frequency bands allocated for cooperative downlink transmission, the respective predetermined frequency band transmission power level of each of the plurality of network nodes based on the stored information.

39. (canceled)

40. A method in a communication network, the method comprising:
in respect of a plurality of frequency bands allocated for cooperative downlink transmission, for which, for each band a respective plurality of predetermined frequency band transmission power levels is used respectively by a plurality of network nodes for cooperative downlink transmission in the frequency band:
receiving channel state information in respect of a mobile terminal indicative of channels between the mobile terminal and each of the plurality of network nodes for at least one of the plurality of frequency bands; and
scheduling the mobile terminal at two or more network nodes of the plurality of network nodes for cooperative downlink transmission in one of the plurality of frequency bands having regard to the channel state information and, for each of the plurality of frequency bands, the respective plurality of predetermined frequency band transmission power levels used respectively by the plurality of network nodes.

41. The method of claim 40, further comprising:
cooperatively transmitting downlink to the mobile terminal from the two or more network nodes of the plurality of network nodes in the one of the plurality of frequency bands allocated for cooperative downlink transmission in which the mobile terminal has been scheduled.

42. The method of claim 40, wherein, for at least one of the frequency bands, the plurality of predetermined frequency band transmission power levels used respectively by the plurality of network nodes for that frequency band are non-identical.

43. The method of claim 40, wherein scheduling the mobile terminal at two or more network nodes of the plurality of network nodes for cooperative downlink transmission in one of the plurality of frequency bands comprises scheduling the mobile terminal for cooperative downlink transmission at each of the network nodes.

44. The method of claim 40, wherein in respect of the plurality of frequency bands, the respective plurality of predetermined transmission power levels used respectively by the plurality of network nodes are predetermined based on optimization of a network performance parameter.

45. The method of claim 44, wherein optimization of a network performance parameter comprises maximizing network throughput.

46. The method of claim 40, wherein scheduling the mobile terminal at two or more network nodes of the plurality of network nodes comprises:
scheduling the mobile terminal at the two or more network nodes on one of the plurality of frequency bands allocated for cooperative downlink transmission having regard to the channel state information and, for each of the plurality of frequency bands, the respective plurality of predetermined frequency band transmission power levels used respectively by the plurality of network nodes.

47. The method of claim 40, further comprising:
for each frequency band of the plurality of frequency bands allocated for cooperative downlink transmission, transmitting to the mobile terminal an indication of the respective plurality of predetermined frequency band transmission power levels used respectively by the plurality of network nodes for the respective frequency band.

48. The method of claim 47, further comprising:
each network node of the plurality of network nodes respectively transmitting, for each of the plurality of frequency bands allocated for cooperative downlink transmission, network node-specific reference symbols at the respective predetermined frequency band transmission power level used by the network node for the respective frequency band.

49. The method of claim 48, wherein transmitting, for each of the plurality of frequency bands allocated for cooperative downlink transmission, a set of network node specific reference symbols comprises transmitting the network node-specific reference symbols commonly to each of a plurality of mobile terminals inclusive of the previously recited mobile terminal.

50. (canceled)

51. (canceled)
